(19) United States
(12) Patent Application Publication
(10) Pub. No.: US 2006/0087739 A1
(43) Pub. Date: Apr. 27, 2006

(54) Low net stress multilayer thin film optical filter

(75) Inventors: Georg J. Ockenfuss, Santa Rosa, CA (US); Brad Pond, Santa Rosa, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/970,531

(22) Filed: Oct. 21, 2004

(51) Int. Cl. G02B 1/10

(52) U.S. Cl. 359/588; 359/586

(57) ABSTRACT

It has been discovered that optical filters can be manufactured with a low net stress by providing a tensile layer or layers that compensate for a compressive stress exhibited by a thin film filter supported by a glass or other substrate. In particular, a simple, cost-effective and readily reproducible process is used wherein a layer or layers of tensile material such as zirconia is used between the thin film filter and the substrate to offset compressive forces within the remaining structure, so as to provide a low or near zero net stress on the filter. Zirconia (ZrO₂) is substantially transparent, inert, and non-interfering, thereby not affecting the output response of the multilayer thin film filter. It's presence is merely to provide a counter stress effectively neutralizing stresses that would otherwise occur from the presence of the thin film filter alone.

### THE FIELD OF THE INVENTION

The present invention is directed to a thin film multilayer filter having a low net stress. More particularly, the present invention is directed to the provision of a compensation structure disposed between a substrate and a multilayer thin film filter, which lessens overall stress of a filter, and decreases warping and delaminating while otherwise substantially unaffecting the intended response of a multilayer thin film filter deposited thereon.

Optical filters have numerous diverse applications related to controlling the reflection, transmission, and absorption of light of varying wavelengths. Many filters comprise very thin layers of materials, often transparent, deposited serially onto the surface of a dielectric or metallic substrate for controlling the way in which the surface reacts to incident light energy. Based on the principle of destructive and constructive interference of light waves, these thin film optical coatings reflect selected portions of the spectrum while transmitting other portions of the spectrum.

The terms “coatings” and “filters” are used interchangeably herein to refer to any type of optical coating deposited on a substrate. Substrates may include inorganic and organic glasses and similar crystalline materials and metals. Suitable substrates for a particular application are selected on the basis of optical properties, for example, internal absorption or transmittance, as well as, physical and chemical properties affecting the stability of the substrate during exposure to various conditions related to handling and manufacturing of the filter and to the environment in which the filter substrate will be used. Substrates may be opaque or light transmissive.

For many optical applications, the coating materials are inorganic, usually consisting of metals, metal oxides such as silicon dioxide, titanium dioxide, zirconium dioxide, etc., and metal nitrides such as silicon nitride, aluminum nitride, boron nitride, etc. Other coating materials include carbides for example, silicon carbide, germanium carbide, etc., fluorides, mixtures of metal oxides, or mixtures of oxides and fluorides. The number of layers in the coating may range from a single thin film layer for very simple antireflection or barrier coatings to multilayer stacks of thin films having more than 50 layers for more complex coatings, such as those, which separate infrared from visible light. Depending on the optical application, the physical thickness of the thin film layers can range in order of magnitude from the angstrom range to the micrometer range. A typical thin film layer physical thickness is on the order of 0.1 μm although relatively much thinner and thicker layers may be commonly used for some types of filters. As used in this application, a “thick” multilayer thin film stack refers to stacks having a physical thickness greater than about 2 μm (2000 nm). In addition to physical thickness, thin film layers may also be usefully described in terms of optical thickness and, particularly, in terms of the quarter wave optical thickness. Thus, it is necessary to specify the type of thickness being described when referring to optical thin films.

As with substrate materials, the coating materials and the physical and optical thicknesses are selected to attain the desired optical properties although the chemical and physical properties of the thin film stacks are a major consideration as well. Composition and microstructure-dependent properties such as mechanical stress, moisture content, crystallization and surface morphology of the thin films affect the reliability and performance of the optical device. For example, excessive mechanical stress such as compressive or tensile stress in an optical coating can result in cracking or delaminating of the coating or warping or breakage of the substrate. Moisture content affects the optical performance, e.g., refractive index, as well as the environmental stability of an optical coating. Crystallization can cause stress-induced cracking and rough morphology resulting in optical scattering and loss of mechanical integrity of the coating. Surface morphology also has effects on optical scatter and physical properties of the film. These properties are affected by factors such as the deposition technique, deposition conditions, deposition rate, material purity and composition, and post-deposition processing such as annealing. Due to the complex interrelatedness of the optical and mechanical properties, both desirable and undesirable effects may occur in response to a particular factor. For example, higher temperatures and lower pressures during coating deposition will typically generate a higher packing density and smaller porosity than low temperature or high-pressure conditions. The higher density provides fewer paths for moisture penetration and smaller surface area for water adsorption and, thus, increased moisture stability. High temperatures, however, may not be compatible with some substrate materials, e.g., many plastics, while lower reactive gas pressures do not produce the stoichiometric compositions having the desired optical properties such as low absorbance.

Another example is post-deposition annealing which may be used to reduce adsorbed water and increase film density. Annealing, however, may also cause degradation of optical performance due to partial crystallization of amorphous materials, interdiffusion between the layers, structure-related alteration of index of refraction or increase in optical scatter, or thermal stress-induced mechanical failure.

Multilayer thin film stacks comprise at least two different coating materials. For many applications, it is useful to alternate a material with a high refractive index with a material with a low refractive index. Silicon dioxide (silica), SiO₂, is a commonly used low refractive index material and is the lowest refractive index material typically deposited with sputter deposition techniques. Thus, multilayer film stacks comprising alternating thin film layers of silica and a high refractive index material are useful for many optical applications.

Evaporation and sputtering are two very useful thin film physical vapor deposition techniques for depositing multilayer thin film stacks. Evaporated thin film layers are typically more porous than sputtered thin film layers. Ion bombardment during deposition with either of these techniques has been shown to advantageously increase the density of the deposited thin films. Silica coatings exhibit an intrinsic compressive stress and the use of silica as the low refractive index material may result in very compressively stressed stacks subject to warping or cracking.

Multiple thin layers of silica in a multilayer thin film stack contribute a significant compressive stress bending moment, particularly for thick multilayer thin film stacks, i.e., stacks having a physical thickness greater than about 2 μm. The denser the silica layers, the greater the intra-layer compressive stress. Thus, sputtered silica films, and particularly ion-assisted sputtered silica films, tend to be very highly compressively stressed. One approach to obtaining a low net stress thin film stack having silica as the low refractive index material is to balance the compressive stress with an identical coating deposited on the opposite surface of the substrate. This approach, however, is not very economical since it requires duplication of a multilayer thin film stack when the desired optical performance can be achieved with a single multilayer thin film stack. Furthermore, this solution is only practicable with transmissive filters having transmissive substrates.

Another approach to obtaining a low net stress thin film stack having silica as the low refractive index material is to balance the compressive stress with a high refractive index material that can provide a compensating, i.e., tensile stress. One source of tensile stress in thin film layers is volume shrinkage that occurs during a post-deposition annealing process. Such shrinkage may be due to crystallization phase changes and/or removal of adsorbed water. Although the crystallization, which occurs during annealing results in shrinkage and an increase in tensile stress, the crystallization also may result in increased optical scatter. To minimize this optical scatter, a carefully controlled partial annealing process can be used to transform the microstructure of the thin film layers to an intermediate state between essentially amorphous and significantly crystalline. Because the partial annealing process must be carefully controlled to limit the extent of crystallization, the amount of tensile stress created is also limited. For that reason, the amount of compressive stress that can be balanced is also limited. Because dense films have more compressive stress than porous films, the compressive stress of the silica may also be balanced by depositing porous high refractive index thin film layers. These optical coatings have reduced moisture stability, however, because of the porous thin film layers. Even though silica has an intrinsic compressive stress, it is possible for a multilayer thin film stack comprising silica alternating with layers of high refractive index material to have an overall net tensile stress due to excessive tensile stress developing within the high refractive index material during the post-deposition annealing process. An excessive tensile stress may also be created in a coating deposited at high temperatures on a low thermal expansion substrate such as fused silica. In addition, depending on the porosity of the thin film layers, the annealing process will remove adsorbed water resulting in shrinkage and an increase in tensile stress in both the silica and the titania or zirconia layers. Thus, even annealing at temperatures below which significant crystallization within the high index material layers occurs, an overall net tensile stress may be created which results in cracking of the film stack or warping and optical distortion in the filter.

One approach to reducing the tensile stress within the high refractive index material utilizes co-deposition of another material, such as silica, to produce composite layers. The composite layers have been shown to have less tensile stress than the pure material layers but the composite layers also have altered optical properties, e.g., decreased index of refraction and increased absorption, which affect the optical performance of the multilayer thin film stack. See, e.g., Russak, M. A., Jahnes, C. V., “Reactive magnetron sputtered zirconium oxide and zirconium silicon oxide thin films,” J. Vac. Sci. Technol. A 7 (3), May/June 1989; 1248-1253; Pond, B. J., DeBar, J. I., Carniglia, C. K., Raj, T., “Stress reduction in ion beam sputtered mixed oxide films,” Applied Optics, Vol. 28 (14), 1989; 2800-2804; Sankur, H., Gunning, W., “Sorbed water and intrinsic stress in composite TiO.sub.2—SiO.sub.2 films,” J. Appl. Phys. 66 (2), 1989; 807-812.

U.S. Pat. No. 5,930,046 in the names of Solberg and Pond, incorporated herein by reference discloses an advance in the art balancing stress by using a multilayer thin oxide to provide methods and apparatus for preparing multilayer thin oxide film coatings. The coating includes alternating layers of a high refractive index material and silica that together have a low net stress and also demonstrate excellent optical performance, virtually no moisture adsorption, and low optical scatter using conventional optical coating deposition techniques and equipment.

Solberg and Pond teach a solution whereby the filter itself is carefully designed so as to minimize overall stress. Careful matching of the layers within the filter itself is required, and a certain amount of freedom in designing of the filter is constrained by considering the relationship between the layers of the filter with respect to any resultant stress. Although the '046 patent appears to perform its intended function, integrating tensile layers into the design of a filter as the high-index material in certain instances is not preferable. For example when a thick coating is required for example in a near infrared blocker this approach may add too many SiO₂ layers to the design, due to the low index of ZrO₂. In this instance the SiO₂ can lead to scatter loss in transmission.

Another U.S. Pat. No. 6,721,100 in the name of Markus Tilsch issued Apr. 13, 2004 assigned to JDS Uniphase Corporation describes a thin film filter sandwiched between a substrate and a superstrate, which apply equal forces to each side of the filter. Although the structure provided by Tilsch is useful and allows tune-ability, there are limitations to this design. The structure does not allow the filter to be outside of the sandwich of superstrate and substrate; and, it must be sandwiched between two same layers applying equal forces. However, ideally, for a reflective filter, it would be preferable to have the filter as the top, outer layer. Furthermore, the invention described in U.S. Pat. No. 6,721,100 requires both the substrate and the superstrate to be light transmissive if they are to be same materials.

In contrast, the instant invention allows the filter to be an outer structure, and further allows the substrate to be light transmissive, light absorbing or reflective, in dependence upon requirements. Matching of characteristics between a substrate and a superstrate is not required. The instant invention is not merely a slight departure from the teachings of Tilsch, but is a significant advance over Tilsch for providing a structure that allows the filter to be separated from the substrate, for example as an outer structure. Merely disposing Tilsch's superstrate adjacent to his substrate to allow the thin film filter to rest upon the substrate superstrate base would not provide the benefits of this invention disclosed hereafter as the forces on the filter would no longer be balanced, since the substrate and superstrate would no longer apply equal and opposite forces to the filter.

In view of the above mentioned prior art techniques, there is a need for providing a structure that will lessen unwanted net compressive stress of an optical filter that includes a substrate and a multilayer coating that would otherwise exhibit an excess of stress in the absence of such a structure. More simply stated, there is a need for a compensating structure adjacent to, but separate from, the thin film filter, that will not affect its performance or desired response to input light, but where at the same time, stress within the optical filter is lessened by the presence of the compensating structure offsetting stress within the thin film filter. The term separate from, does not imply, separated by a gap, but is intended to mean, a separate structure, wherein the compensating structure supports the thin film optical filter adjacent to it.

What is required is a compensating layer or layers, between the multilayer filter and the substrate that will provide tensile stress substantially equal and opposite to a compressive stress exhibited by a substrate supported multilayer filter carried by the compensating layer or layers.

Advantageously, such a structure provides the benefit of offsetting unwanted stresses within the thin film filter while allowing essentially complete freedom in designing the thin film filter without taking into account unwanted stress that may result from the thin film filter layers.

### SUMMARY AND OBJECTS OF THE INVENTION

It is an object of the present invention to provide a compensating structure for use with a multilayer thin film filter that will provide an optical filter with a low net stress.

In particular, it is an object of the invention to provide a stress compensating structure that will essentially unaffect the response or performance of the multilayer filter it is compensating.

These and other objects and features of the present invention will become more fully apparent from the following description and appended claims, or may be learned by the practice of the invention as set forth hereinafter.

In accordance with the present invention an optical filter is provided comprising a substrate; a multilayer filter, supported by the substrate, for providing a predetermined output response to input light passing therethrough; and, a compensating structure including one or more layers of light transmissive material, the compensating structure substantially unaffecting the predetermined output response of the multilayer filter when said input light passes through the compensating structure and the multilayer filter, the compensating structure disposed between the multilayer filter and the substrate for providing a tensile stress substantially approximately offsetting a compressive stress resulting from the multilayer filter and the substrate so as to substantially prevent the filter from warping or delaminating.

This invention provides a multilayer structure that may be a single layer of tensile material that is stress compensating; or plural layers maybe provided having thin barrier layers therebetween. A preferred material for the compensating layer is zirconia. In addition the single or multilayers of compensating material one or more matching layers may be provided for better matching the refractive index of the substrate with the compensating layer or layers.

This invention provides a compensating structure in the form of a quasi-single layer of ZrO₂ between the substrate and the coating design to compensate for the compressive stress, while overcoming the major drawbacks of prior art solutions described heretofore. This invention provides a solution, which has little or no impact on the spectral performance of the coating design itself.

### BRIEF DESCRIPTION OF THE DRAWINGS

Prior art embodiments and exemplary embodiments of the invention will now be described in conjunction with the drawings in which:

FIG. 1 is a prior art diagramatic representation of a flat substrate suitable for accommodating a thin film filter.

FIG. 2 illustrates diagram of the substrate shown in FIG. 1 having a thin film multilayer coating deposited thereon.

FIG. 3 is a diagram illustrating the filter and substrate of FIG. 2 including a stress compensation layer provided by coating a compressive coating on a second side of the substrate.

FIG. 4 is a diagram of a substrate as shown in FIG. 1, having a portion of a filter deposited on a top side of the substrate and having a portion on a bottom side of the substrate.

FIG. 5a is a diagram of a pre-bent substrate; and FIG. 5b is a diagram illustrating a filter deposited on the pre-bent substrate of FIG. 5a, wherein the resulting filter of FIG. 5b is shown to be flat.

FIG. 6 is a diagram illustrating a filter having compensation tensile layers incorporated within the thin film filter itself and together with adjacent layers forming the thin film filter.

FIG. 7 is a diagram of the optical filter in accordance with an embodiment of this invention, wherein a compensating structure is shown disposed between a multilayer thin film filter and the substrate.

FIG. 8 is a graph depicting warp as a function of ZrO₂ layer thickness showing a 40 nm thick ZrO₂ nano-layer, and thick to a 150 nm thick nano-layer, respectively for parts baked at 200° C.

FIG. 9 is a graph illustrating transmission measurements of a coating without ZrO₂, with a ZrO₂ layer build of thick nano-layers (150 nm) and thin nano-layers (40 nm).

FIG. 10a and 10b illustrate the structure of a quasi-single layer of ZrO₂ comprising thick nano layers (150 nm) and thin nano-layers (40 nm) respectively.

FIG. 11 is a graph illustrating warp versus post bake temperature.

FIG. 12 illustrates a filter in accordance with this invention wherein matching layers are provided between the substrate and the compensating structure.

FIG. 13 is a graph showing a comparison of a spectral response of a filter with and without a stress compensation layer.

FIG. 14 is a graph showing the minimal “optical” effect of the presence of the stress compensation layers as the thickness of quasi-layer is varied by + and −10% in increments of 0.5% for the IR filter of FIG. 13.

FIG. 15 is a plot of cut-off wavelength change versus ZrO₂ thickness variation.

FIG. 16 is a graph which illustrates a change in average and minimum transmission of an IR blocking filter in the passband.

### DETAILED DESCRIPTION

Stresses in a thin film can have several components. Intrinsic stresses develop as the film is being formed and achieves a specific microstructure having specific grain characteristics and intergrain forces.

A second major source of stress is due to the differences in the coefficient of thermal expansion of the film and that of the substrate or adjacent film layers causing the different materials to experience different degrees of expansion and shrinkage upon, respectively, heating and cooling. Because typical deposition temperatures are higher than ambient temperatures, stress develops when the temperature changes from the deposition temperature. Even when films are deposited nominally at room temperature, some heating of the substrate can occur during the deposition and condensation process. Finally, temperature variations during use may lead to changes in the stress level. The sign of the thermally induced stress can change from tensile to compressive, or vice versa, as it is a function of the differences in the thermal expansion coefficients of the film and substrate materials. Thus, many factors affect the overall net stress of an optical coating. Multilayer thin film stacks comprising alternating layers of high refractive index oxide material and low refractive index oxide material are used for many types of optical coatings or filters. Silica (silicon dioxide) is a very useful low refractive index material. Thin film layers of silica, however, have intrinsic compressive stress. Excessive stress in an optical coating can result in cracking or delaminating of the coating or optical distortions due to bending or warping of the substrate. Thus, particularly for thick optical coatings, i.e., coatings greater than about 2 μm (2000 nm), the compressive stress bending moment of the silica layers can be excessive. Silica-based glasses are preferred substrates for many optical coatings because of their low cost, broad range of available sizes and shapes, and excellent optical properties. Two high refractive index oxide materials compatible with glass substrates are titania (titanium oxide) and zirconia (zirconium oxide). A common technique to densify and stabilize titania and zirconia thin film layers involves a post-deposition annealing process. Annealing results in volume shrinkage of the thin film layers due to removal of adsorbed water, if present, and to crystallization phase changes. Because the thin film layers are constrained by the substrate, which does not shrink, this volume shrinkage results in the development of tensile stress within the film layers. Indeed, the integrated tensile stress may exceed the integrated compressive stress of silica resulting in multilayer thin film stacks having an excessive net tensile stress also resulting in loss of mechanical integrity or poor optical performance. In addition, the crystallization that occurs during annealing may contribute to increased optical scatter, which also degrades optical performance. Optical coatings having net tensile stress produce concave net curvature of the substrate whereas compressively stressed coatings result in a convexly curved substrate. For this reason, net film stress may be approximated from measurements of the net curvature of the coated substrate, i.e., the curvature change from the original substrate curvature. For example, one method for evaluating net curvature is to measure the number of fringes at a selected wavelength with an interferometer and converting the information into a stress value. Conventional knowledge maintains that optical coatings comprising a substrate having multilayer optical coatings comprising alternating layers of silica and high refractive index metal oxide material deposited thereon will generally have some net stress, either compressive or tensile depending on preparation technique and the specific alternating materials.

Prior to the present invention, dense sputtered or ion assisted evaporated coatings having alternating layers of silica and a high refractive index metal oxide have typically had stresses of 100×10⁶ Pa (kg/(m•s²)) or more.

The optical filter prepared in accordance with the present invention, having a conventional thin film coating including a compensating structure separate from and in addition to the filter, however, have significantly lower net stresses typically less than 100×10⁶ Pa and preferably less than 20×10⁶ Pa. Thus, as used herein, the phrase “low net stress optical device” refers to an optical device comprising a substrate and a compensating tensile structure comprising a layer or layers supporting a multilayer optical coating comprising alternating layers of high and low refractive index material deposited thereon wherein the net curvature of the filter is measured with an interferometer at a selected wavelength of interest, is on the order of one-half to one-tenth, of a typical net curvature in a currently available optical device comprising a similar substrate having same multilayer coatings in the absence of the compensating structure disposed between the multilayer filter and the substrate.

It is a feature of the present invention to provide and control a quasi-single layer of the compensating structure to thereby achieve a desired tensile stress that will offset a compressive stress anticipated by thin film filter layers to be deposited thereon in the presence of the substrate. Of course this anticipated stress can be calculated in advance of depositing the compensating structure, or alternatively can be calculated by fabricating an optical filter in the absence of the compensating structure to determine a required tensile stress to offset the compressive stress.

It has been discovered that unwanted scattering can be substantially reduced by splitting the high refractive index material, such as zirconia or titania, into sub-layers forming a quasi-single layer, comprising plural layers of zirconia or titania separated by very, very thin layers, i.e., 1-2 nm, of a different isolator material thereby forming a quasi-single layer of zirconia. The isolator material should be light transmissive and physically inert with respect to the high refractive index material so as not to affect the physical properties. Because of the extreme thinness of the isolator material layer, substantially no optical effect is observed even with a low refractive index material such as silica. By providing the thin layers the growth of larger crystal in the zirconia layer is inhibited; thus, to achieve this, it is necessary to break up the zirconia structure at least every 50 nm with the different very thin coating material. By way of example, 2.5 nm-4 nm thick Nb₂O₅ and 35 nm-43 nm thick ZrO₂ layers were used. Polycrystalline ZrO₂ layers leads to large scatter losses and a reduction in transmission.

The tensile effect of ZrO₂ can be enhanced by baking the quasi-single layer at high temperatures. With an increase of temperature the layer becomes more tensile than an SiO₂ thin film layer becomes compressive due to structural changes. Therefore, thinner compensation layers may be provided if the parts are baked after coating.

Thus conveniently and advantageously, since the compensation layer is deposited prior to the thin film filter layers, the compensation layer can be baked at higher temperatures than the thin film filter can withstand, prior to depositing the thin film filter thereon.

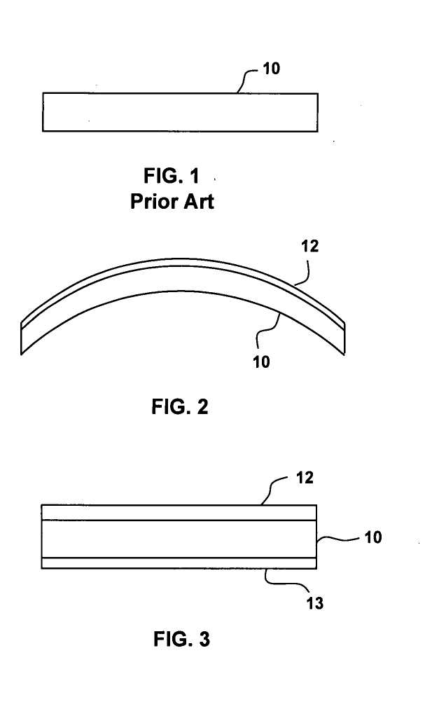

FIG. 1 through FIG. 6, which follow, illustrate aforementioned prior art solutions, some of which have gained more industry acceptance than others.

Referring now to FIG. 1 a flat glass substrate 10 is illustrated which forms a support for a thin film filter shown deposited thereon in subsequent figures. Of course other materials can be used that are compatible with the filter and process for depositing the filter thereon. It will be appreciated that the substrate and coating material in subsequent figures are not drawn to scale. The physical thickness of each coating material is determined by the design of the optical coating. In its uncoated state the substrate is substantially flat.

In FIG. 2 the same substrate 10 is shown having a thin film multilayer coating 12 deposited thereon, wherein the coating exhibits an unwanted compressive stress, thereby providing an unwanted net compressive stress on the substrate 10, causing it to warp.

In contrast, the filter shown in FIG. 3 includes a stress compensation layer 13 provided by coating a compressive coating on a second side of the substrate. By providing equal compressive stresses on opposite sides of the filter, a net compressive stress on the substrate 10 is essentially nulled.

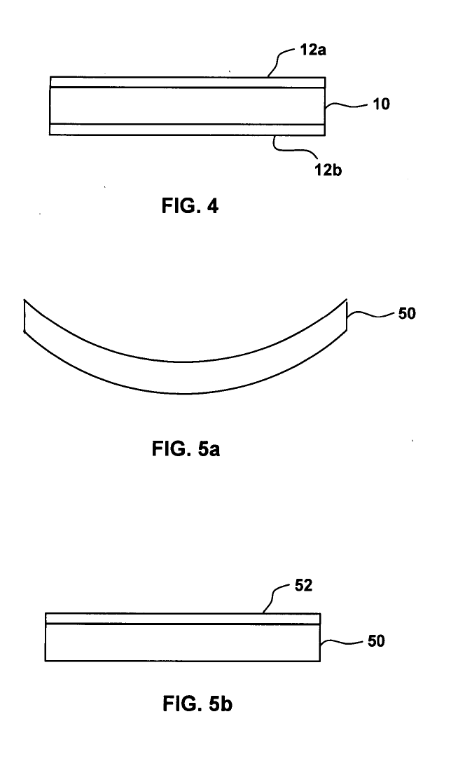

FIG. 4 is similar to FIG. 3, however, the filter to be deposited is separated into two similar thin film multilayer filters 12a and 12b each having about half of the thickness of the desired overall filter 12 of FIGS. 2, and 3. In this manner each half is deposited on an opposite side of the substrate 10, wherein each filter 12a and 12b exhibits substantially same characteristics. Notwithstanding, this limits the filter designer to being constrained to break up the thin film filter into two equal portions; furthermore, difficulties with depositing on both sides of the substrate are encountered. Either flip-tooling is necessary to apply this second coating without breaking the vacuum in the vacuum chamber, or a second coating run is required, which is likely to increase the handling and defect density.

Turning now to FIGS. 5a and 5b, a figure is shown of another prior art method of achieving a multilayer thin film filter coated on a substrate wherein the overall net stress is near zero. Initially a pre-bent substrate 50 is provided having a bend that will be offset resulting in a flat filter when the bent substrate is coated with a thin film multilayer filter 52 having a net compressive stress essentially forcing the bent filter to be flat. Some of the drawbacks to this solution are quite evident. For example providing precisely the correct amount of bend in the substrate to be offset by the filter is not trivial; furthermore, the cost of this solution is excessive, and different substrates are required for filters having different compressive forces.

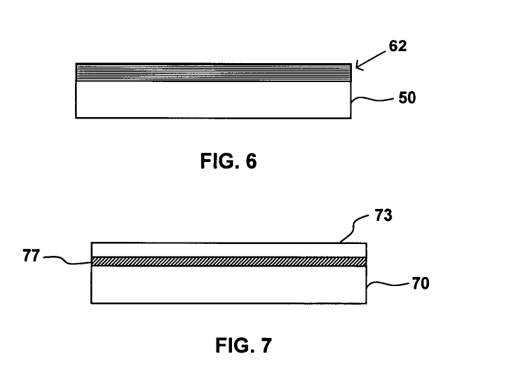

FIG. 6 is a diagram illustrating a filter having compensation tensile layers incorporated within the thin film filter itself and together with adjacent layers forming the thin film filter. As was mentioned heretofore, this solution does achieve its desired result, however constrains the filter designer to considering the stresses as the thin film filter is being designed. Furthermore, the refractive indices and thickness of the multilayers must also be considered and accounted for, since the compensation structure is part of the multilayer filter itself.

FIG. 7 illustrates schematically a preferred embodiment of the low stress the optical filter in accordance with an embodiment of this invention, wherein a compensating structure 77 is shown between the thin film filter 73 and the substrate 70. A glass substrate 70 is coated with alternating multiple layers of light transmissive zirconia having a thickness of 35 nm-43 nm and Nb2O₅ having a thickness of 1 nm-4 nm. It will be appreciated that the substrate and coating materials are not drawn to scale.

Clearly this embodiment offers advantages not heretofore realized in the aforementioned prior art solutions. For example, this structure does not require careful consideration of the materials and stresses of the multilayer thin film filter itself. The compensating structure beneath the filter merely must offset all net forces exhibited by the thin film filter supported by the substrate to yields an overall optical filter with little or no net force. Flip-tooling is not required as the compensating structure is deposited in a manner similar to the thin film layers deposited thereon. Advantageously the compensating structure can be baked to higher temperatures than the multilayer thin film filter can withstand, since this compensating layer is deposited prior to the multilayer thin film filter.

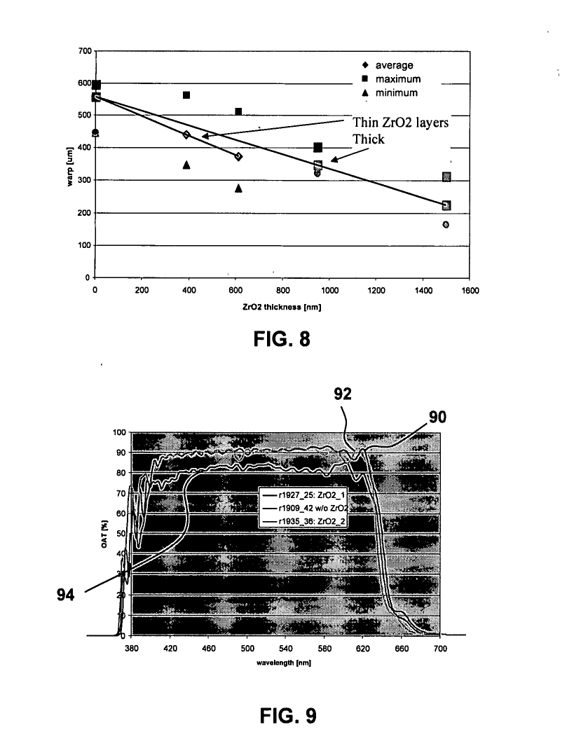

FIG. 8 is a graph depicting an amount of warp present as a function of ZrO₂ layer thickness showing a 40 nm thick ZrO₂ nano-layer, and thick to a 150 nm thick nano-layer, respectively for parts were baked at 200° C. The dimension of the glass substrate was 60×60 mm² large with a thickness of 0.3 mm.

FIG. 9 is a graph illustrating transmission measurements of a coating without ZrO₂, with a ZrO₂ layer build of thick nano-layers (150 nm) and thin nano-layers (40 nm). The plot referenced as 90 is the response of the filter alone in the absence of a compensating structure or substrate. The optical performance, i.e. the least affect on the response of the filter was afforded with the thin compensation single quasi-layer having a thickness of 40 nm. This is shown by the plot referenced as 92 in the figure. As is evident from the graph, the filter response 94 with thicker compensation quasi-layer of ZrO₂ optically performed the worst, that is, changed the output response of the filter the most.

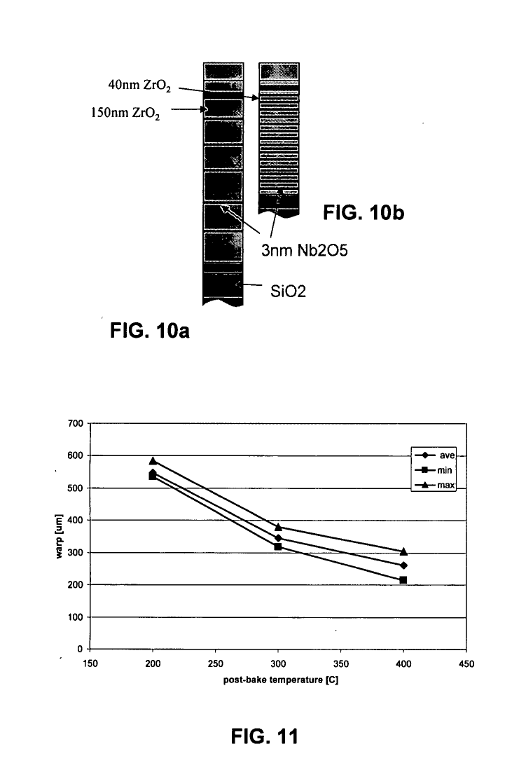

The two structures shown in FIGS. 10a and 10b correspond to the output response plots 92 and 94 respectively of FIG. 9. FIG. 10a illustrates the structure of a quasi-single layer of ZrO₂ comprising thick nano-layers each having a thickness of 150 nm and FIG. 10b illustrates thin nano-layers having a thickness each of 40 nm respectively. In both structures thinner layers of Nb₂O₅ having a thickness of 3 nm separates the zirconia to prevent large crystals from forming.

FIG. 11 illustrates that one can achieve the desired results of a totally flat warp wherein the warp is essentially zero by appropriately selecting the correct ZrO₂ layer thickness and post bake temperature. It was desired to have the warp below 500 μm in this experiment.

In a preferred embodiment, matching layers are provided for matching more closely the refractive index of the substrate and that of the compensating structure. Preferably, a matching layer or layers are disposed between the substrate and the compensating structure. In this instance the refractive index of the matching layer is selected to be between the refractive index of the substrate and that of the one or more layers of the compensating structure. Suitable matching materials compatible with the use of zirconia as a compensating material are Al₂O₃, ZrO₂ and SiO₂ depending on the substrate material. The matching layers can be comprised of different materials having different refractive indices between those of the substrate and the compensating material.

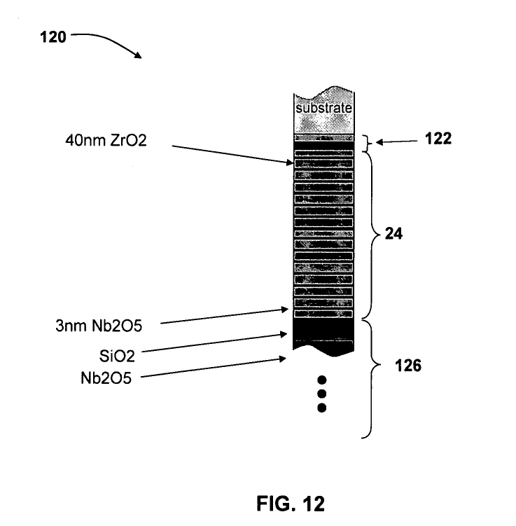

FIG. 12 illustrates a filter 120 in accordance with this invention wherein matching layers 122 are provided. The substrate 121 is first coated with matching layers 122 consisting of a layer of ZrO₂ and a layer of SiO₂. The quasi-single layer stress compensation layer 124 comprising alternating layers of ZrO₂ each having a thickness of 40 nm and Nb₂O₅ layers 3 nm in thickness is deposited on the matching layers 122. A multilayer filter comprising layers of SiO₂ and Nb₂O₅ 126 are shown deposited upon the stress compensation layer.

By way of example a design of a filter in accordance with an embodiment of the invention is hereafter disclosed wherein a substrate supports a matching layer having a stress compensating layer thereon having deposited upon the stress compensating layer an IR blocking filter. The filter parameters are as follows, wherein the symbol * following numbers has the meaning of physical thickness in nanometers, and wherein the symbols H, P, and L, represent ZrO2, Nb2O5, and SiO2 respectively. A number following parentheses has the meaning, to the power of, number of repetitions, in this instance 17. The filter parameters are as follows:

substrate

(matching layer) 18.4814*H 22.9649*L

(stress compensating layer) (35*H 3*P )17 20*H

(IR blocking design) 151.764*L 82.3792*P 135.9166*L 74.8096*P 135.3628*L 71.9631*P 136.3234*L 71.1869*P 136.6725*L 71.9162*P 136.615*L 74.0221*P 137.2788*L 78.1684*P 142.1437*L 86.8728*P 159.1152*L 104.6733*P 169.2959*L 100.8465*P 161.7632*L 100.5399*P 168.0637*L 105.041*P 168.7331*L 102.6465*P 166.8282*L 104.2894*P 170.5657*L 104.5105*P 166.4171*L 102.5974*P 170.3602*L 105.6715*P 163.0895*L 89.5252*P 72.7915*L

air

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Samples were prepared in the JDSU MetaMode® coating machine having a drum circumference of 355 cm, sputter cathodes 132 cm long and 12.7 cm wide, and dual, 122 cm long, ion gun anodes. The deposition rates were 3 Å/s for zirconia, 2.3 Å/s for niobia and 2.1 Å/s for silica. All the target materials were metallic. The table below summarizes the deposition conditions for each material:

| | | coating | | |
|---|---|---|---|---|
| | | Nb2O5 | SiO2 | ZrO2 |
| Ar-gas flow | [sccm] | 640 | 500 | 440 |
| O2-gas flow | [sccm] | 500 | 150 | 255 |
| process pressure | [Pa] | 0.3 | 0.4 | 0.1 |
| Ion-gun current | [A] | 30 | 22 | 28 |
| cathode power | [kW] | 9.6 | 12 | 12 |
| cathode voltage | [V] | 340 | 550 | 400 |

Typical sample size were 60 mm square glass plates which were 0.3 mm thick. Without using the ZrO2 compensation layer we measured a warp of 0.55 mm for a 4.5 um thick coating design described above for an IR-blocking filter. Warp in this instance is defined as the vertical dislocation between the four edges of the sample and the center of the sample.

For every 0.1 mm in reduction of warp 330 nm of ZrO2 have to be added and baked at 400 C. i.e. to achieve flat samples a zirconia thickness of 1.8 um would be required. In one specific application, where the goal was to have warp of less than 0.5 mm a ZrO2 coating thickness of 650 nm was sufficient to meet the specification.

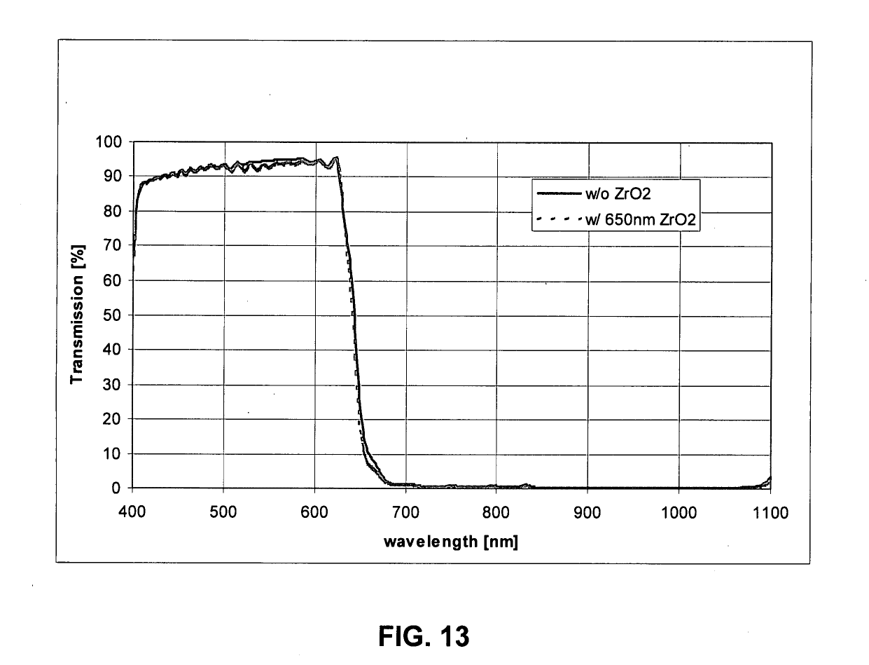

FIG. 13 is a graph that shows a comparison of the spectral response of a filter with a 650 nm thick ZrO₂ stress compensation layer indicated by the line 130 and without a stress compensation layer indicated by the line 132. It should be noted that the plot of indicated by the line 132 without compensation is a plot of the idealized filter without any warp to the substrate. It is evident from the plot that the compensation layer is essentially “optically” unaffecting the output response.

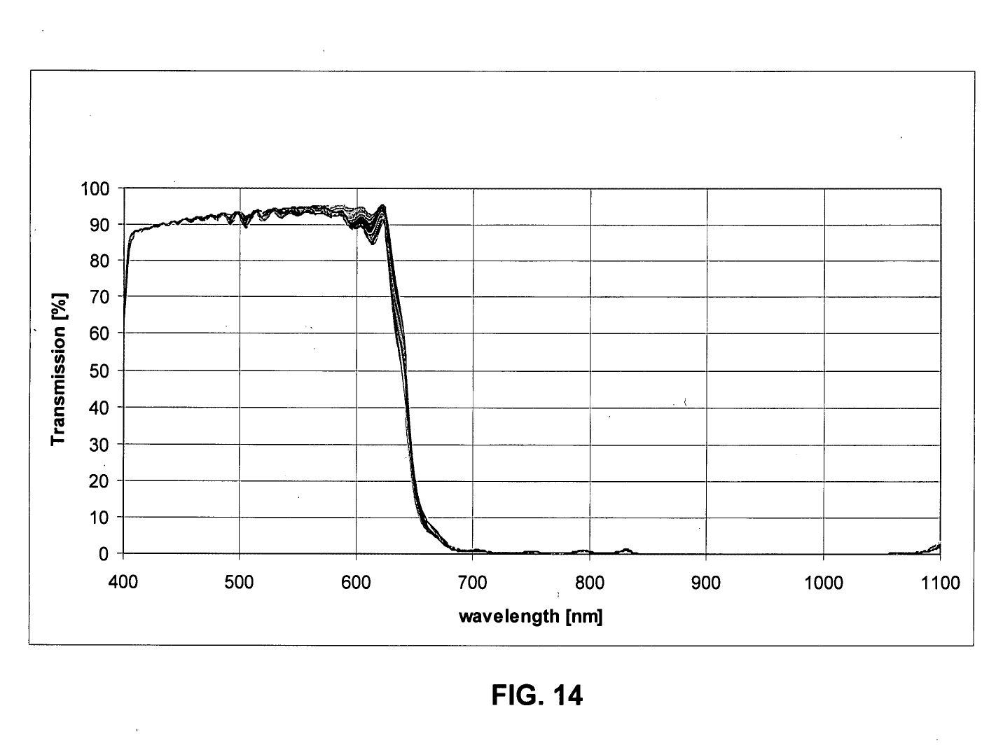

FIG. 14 further illustrates the minimal “optical” effect of the presence of the stress compensation layers as the thickness of quasi-layer is varied by + and −10% in increments of 0.5%. Advantageously, a great deal of freedom is provided in selecting a thickness for compensating for different amounts of stress while negligibly affecting the filter's intended output response.

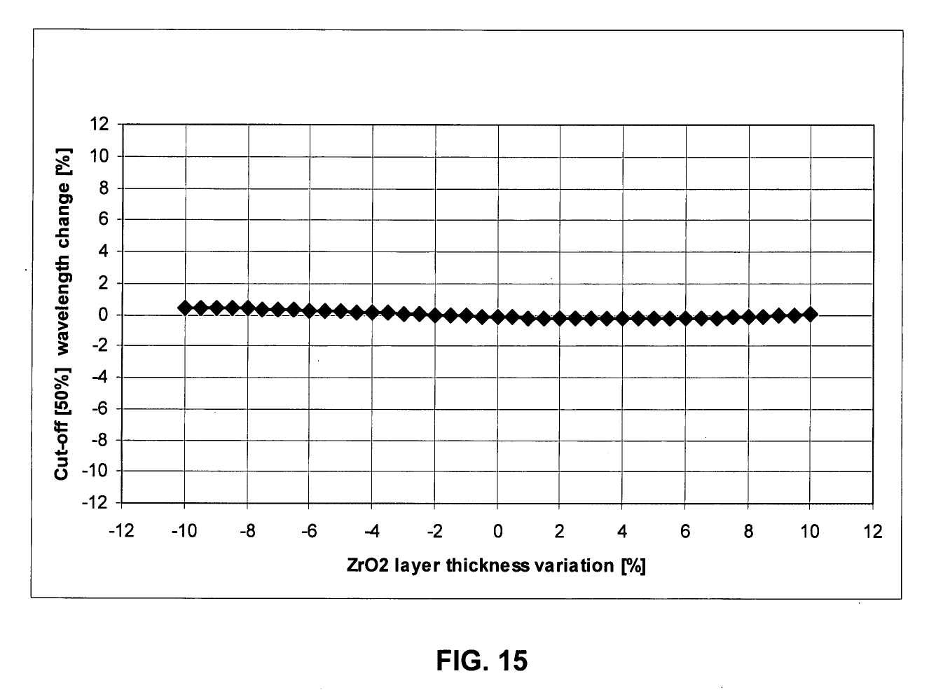

FIG. 15 is a plot of cut-off wavelength change versus ZrO₂ thickness variation. The graph shows the variation in cut-off wavelength of an IR blocking filter where the thickness of a 650 nm thick ZrO₂ stress compensation layer is varied by + and −10%. This illustrates that the compensation layer is essentially unaffecting the spectral response of the filter as the thickness is varied.

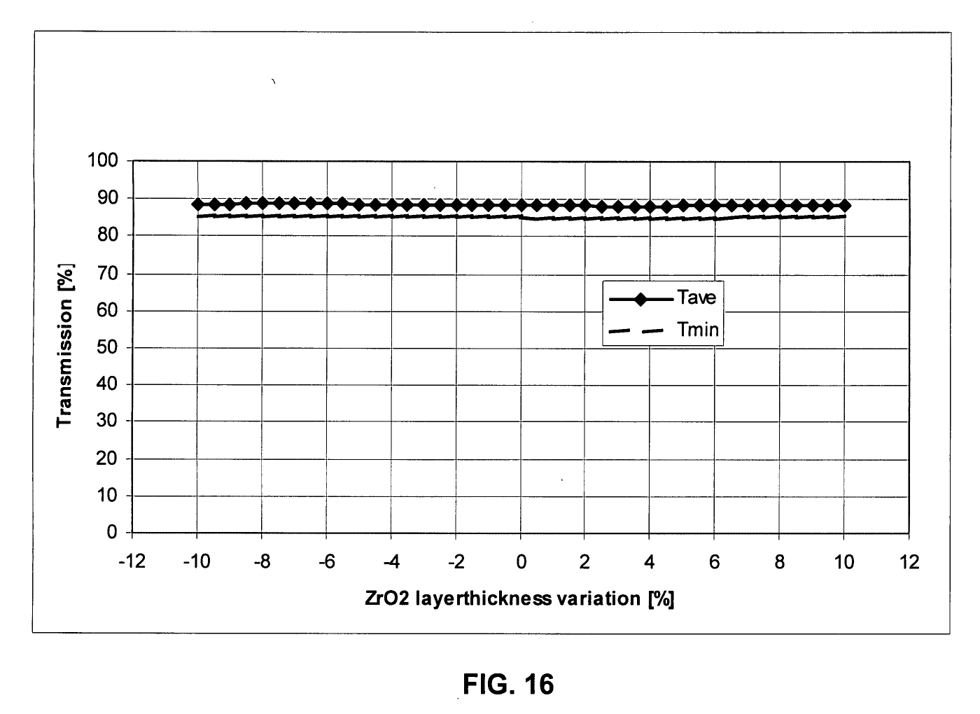

FIG. 16 illustrates a change in average and minimum transmission of an IR blocking filter in the passband. As the thickness is varied by +−10% the compensation layer is essentially unaffecting the spectral response of the filter.

Of course, as previously mentioned, numerous other embodiments may be envisaged, without departing from the spirit and scope of the invention, and for example the multilayer thin film filter could include a solid structure such a mirror or absorber.

What is claimed is:

1. An optical filter comprising: a substrate; a multilayer filter supported by the substrate, for providing a predetermined output response to input light passing therethrough; and, a compensating structure including one or more layers of light transmissive material, the compensating structure substantially unaffecting the predetermined output response of the multilayer filter when said input light passes through the compensating structure and the multilayer filter, the compensating structure disposed between the multilayer filter and the substrate for providing a tensile stress substantially offsetting compressive stresses from the multilayer filter and the substrate so as to substantially prevent the filter from warping or delaminating.

2. An optical filter as defined in claim 1, wherein the compensating structure comprises a plurality of layers of a first, substantially inert material, the layers having a thickness of less than 60 nm separated by a thin layer of a different material having a thickness of less than 5 nm.

3. An optical filter as defined in claim 1 wherein the substrate has an index of refraction nₛ and wherein one or more matching layers having a refractive index nₘ are disposed between the compensating structure and the substrate, and wherein the one or more layers of the compensating structure excluding the one or more matching layers has an effective refractive index of refraction n_{c} and, wherein nₛ<nₘ<n_{c}.

4. An optical filter as defined in claim 3, wherein the one or more layers includes plural layers of different materials and wherein the effective refractive index of the plural layers is nₘ.

5. An optical filter as defined in claim 3, wherein the first material is selected from the group of materials consisting of: zirconia, and titania.

6. An optical filter as defined in claim 1 wherein the one or more layers of material of the compensating structure includes layers of zirconia having a thickness of less than 60 nm, wherein at least some of the layers are separated by a thin layer of different material having a thickness of less than 10 nm.

7. An optical filter as defined in claim 6 wherein the thin layer of the different material is Nb₂O₅.

8. An optical filter as defined in claim 3 wherein the matching layers are comprised of high and low refractive index layers.

9. An optical filter as defined in claim 3 wherein the matching layers are comprised of at least one of Al₂O₃, ZrO₂ and SiO₂.

10. An optical filter as defined in claim 1, wherein the multilayer filter is an IR blocking filter, a bandpass filter, a WDM filter, a hot mirror, a cold mirrors, a shortwave pass, a C-plate, a longwave pass filter, or a thick AR filter.

11. An optical filter as defined in claim 1 wherein the multilayer filter exhibits a compressive stress of at least 300 MPa and wherein the net stress of the optical filter structure is less than 100 MPa.

12. An optical filter as defined in claim 1 wherein the multilayer filter exhibits a compressive stress of at least 100 MPa and wherein the stress of the net stress of the optical filter is less than 20 MPa.

13. An optical filter as defined in claim 2 wherein the multilayer filter exhibits a compressive stress of at least 100 MPa and wherein the stress of the net stress of the optical filter is less than 20 MPa.

14. An optical filter as defined in claim 1 wherein the compensating structure provides an amount of tensile stress such that the net stress of the optical filter is less than about 100 MPa.

15. An optical filter as defined in claim 2 wherein the compensating structure provides an amount of tensile stress such that the net stress of the optical filter is less than about 20 MPa.

16. An optical filter as defined in claim 1, wherein the output response of the multilayer filter within an operating wavelength range of wavelengths is affected by less than 5% by the presence of the compensating layer.

17. An optical filter as defined in claim 1, wherein the output response of the multilayer filter within an operating wavelength range of wavelengths is affected by less than 0.5% by the presence of the compensating layer.

18. An optical filter comprising: a substrate; a multilayer filter, supported by the substrate, for providing a predetermined output response to input light passing therethrough; and, a compensating structure including one or more layers of light transmissive material, substantially unaffecting the predetermined output response of the multilayer filter when said input light passes through the compensating structure and the multilayer filter, the compensating structure disposed between the multilayer filter and the substrate for providing a first stress substantially offsetting stresses resulting from the multilayer filter and the substrate so as to substantially prevent the filter from warping, wherein the compensating structure comprises a plurality of layers of a first, substantially inert material, the layers having a thickness of less than 60 nm separated by a thin layer of a different material having a thickness of less than 5 nm, wherein the substrate has an index of refraction ns and wherein the compensating structure includes one or more matching layers between one or more layers of the compensating structure with an effective index nₘ and wherein the one or more layers of the compensating structure excluding the one or more matching layers has an effective refractive index of refraction n_{c} and, wherein nₛ<nₘ<n_{c}, wherein the one or more layers includes plural layers of different materials and wherein the effective refractive index of the plural layers is n_{c}.

19. An optical filter as defined in claim 18, wherein the first material is selected from the group of materials consisting of: zirconia, and titania.

20. A method of fabricating a flat layered optical filter comprising the steps of:
a) providing layers of materials which together provide a multilayer filter having predetermined output response;
b) determining an unwanted net compressive stress exhibited by the combined layers of materials;
c) selecting an optically neutral material that exhibits a net tensile stress as a material for a compensating structure;
d) determining a number of layers and thickness of said layers of the optically neutral material that will substantially offset the unwanted net compressive force in combination with thin barrier layers therebetween;
e) forming the optical filter by providing the substrate for supporting the multilayer filter having the compensating structure therebetween.

21. A method of fabricating a flat layered optical filter as defined in claim 20, wherein the step of forming the filter is provided by first depositing one or more layers upon a substrate to provide the compensating structure; and subsequently depositing the multilayer filter over the compensating structure.

22. A method as defined in claim 21 wherein the compensating structure is deposited in a first deposition chamber and wherein the multilayer filter is deposited in a second deposition chamber.
